(19) United States
(12) Patent Application Publication
(10) Pub. No.: US 2024/0250613 A1
(43) Pub. Date: Jul. 25, 2024

(54) DYNAMIC CURRENT LIMIT CIRCUITRY FOR POWER CONVERTERS

(71) Applicant: Texas Instruments Incorporated, Dallas, TX (US)

(72) Inventors: Benjamin M. McCue, Knoxville, TN (US); Ryan Lind, Knoxville, TN (US)

(21) Appl. No.: 18/375,242

(22) Filed: Sep. 29, 2023

Related U.S. Application Data
(60) Provisional application No. 63/440,173, filed on Jan. 20, 2023.

(51) Int. Cl. H02M 3/158; H02M 1/00

(52) U.S. Cl. CPC H02M 3/158; H02M 1/0006; H02M 1/0009

(57) ABSTRACT

Systems, apparatus, articles of manufacture, and methods are disclosed to dynamically limit current for power converters. An example switch control circuitry configured to control a plurality of switches based on a loop voltage to control inductor current through a inductor; loop gain circuitry configured to generate the loop voltage based on an input voltage and a reference voltage; and clamping circuitry configured to clamp the loop voltage after the loop voltage exceeds a threshold, the switch control circuitry configured to clamp the inductor current based on the clamping of the loop voltage, wherein the clamping of the inductor current clamps an input current.

### CROSS-REFERENCE TO RELATED APPLICATION

This application claims priority to U.S. Provisional patent application No. 63/440,173, filed Jan. 20, 2023, which is incorporated herein by reference in its entirety.

### TECHNICAL FIELD

This disclosure relates to circuits, and, more particularly, to dynamic current limit circuitry for power converters.

### BACKGROUND

Power converter circuitry (also referred to as a voltage regulator, converter circuitry, regulator circuitry, voltage regulator circuitry, etc.) is used to provide a regulated voltage and/or current operating on a supply voltage. Power converter circuitry may include circuitry to limit current and/or voltage spikes and/or dips due to sudden changes in a load (e.g., transient conditions). Such circuitry attempts to ensure that one or more voltages and/or currents associated with the power converter circuitry is at or near the intended value regardless of changes in the load.

### SUMMARY

In a described example, a circuit includes an inductor; a plurality of switches coupled to the inductor; switch control circuitry configured to control the plurality of switches based on a loop voltage to control the inductor current through the inductor; loop gain circuitry configured to generate the loop voltage based on an input voltage and a reference voltage; and clamping circuitry configured to clamp the loop voltage after the loop voltage exceeds a threshold, the switch control circuitry configured to clamp the inductor current based on the clamping of the loop voltage, wherein the clamping of the inductor current clamps an input current.

### BRIEF DESCRIPTION OF THE DRAWINGS

FIG. 1 is a block diagram of example power converter circuitry.

FIG. 2 is a circuit diagram to implement the example power converter circuitry of FIG. 1.

FIG. 3 is a circuit diagram of the example clamping circuitry of FIG. 2.

FIG. 4 is a circuit diagram of the example divide-by-duty cycle circuitry of FIG. 3.

FIG. 5 is a circuit diagram of an alternative implementation of a portion of the divide-by-duty cycle circuitry of FIG. 4, in an example.

FIG. 6 illustrates timing diagrams corresponding to examples disclosed herein.

FIGS. 7-8 are flowcharts representative of exemplary methods and/or operations that may be executed by one or more portions of the power converter of FIGS. 1-5.

### DETAILED DESCRIPTION

Example embodiments relate to determining properties of inductors in power converters, such as a switch mode power supplies. For example, a power converter has a power stage that includes switch circuit and an inductor. In some examples, power converters are used in battery chargers and/or alternating current (AC) adapters. A battery charger may distribute power from a voltage source to charge a battery that is used to power the rest of the system. To avoid overloading the power converter and/or other parts of the system, there may be current and/or voltage overshoot requirements (e.g., to ensure that an output current, an input current, an input voltage, and/or an output voltage does not go above a threshold amount). To avoid overshoot of a current and/or voltage, some power converters utilize loop circuitry to stabilize currents and/or voltages to desired levels. Although, such loop circuitry is accurate in ensuring that a current and/or voltage output from a voltage source and/or an inductor is stable, such circuitry needs time to stabilize the current and/or voltage. As described herein, an input voltage corresponds to a voltage source that the power converter uses to regulate to a different output voltage. The input voltage generates an input current. The output terminal of the power converter outputs the regulated output voltage, which is provided to a load. Additionally, the output current is the amount of current drawn by the load. As used herein, circuit and circuitry can be used interchangeably.

When a transient condition occurs (e.g., the load quickly changes to draw more or less current from the power converter), such loop circuitry may not be fast enough to avoid overshoots caused by the transient condition. Accordingly, the current and/or voltage that is supposed to be stabilized by the loop circuitry might become too high or too low. Overcurrent and/or overvoltage may cause damage to the power converter, the adapter, and/or other parts of the system. Overcurrent and/or overvoltage can occur at the input of the power converter, at the output of the power converter, and/or at any other node of the power converter.

Examples disclosed herein provide fast overcurrent and/or overvoltage protection that occur during transient conditions. Examples disclosed herein utilize a clamp that is stabilized by loop circuitry and clamps a voltage and/or current. For example, to clamp an input current of a power converter, examples disclosed herein clamp a loop voltage used by the loop circuitry to adjust an inductor current. Accordingly, by clamping the loop voltage, examples disclosed herein clamp the inductor current. Because the inductor current is a function of the input current, clamping the inductor current clamps the input current. The clamping circuitry disclosed herein can limit the peak input current for a duration of time after a transient event until the loop circuitry can maintain control of the input current to accurately stabilize the input current. Using examples disclosed herein, overshoot input current (e.g., the peak current in response to a transient event) can be reduced by approximately 29%.

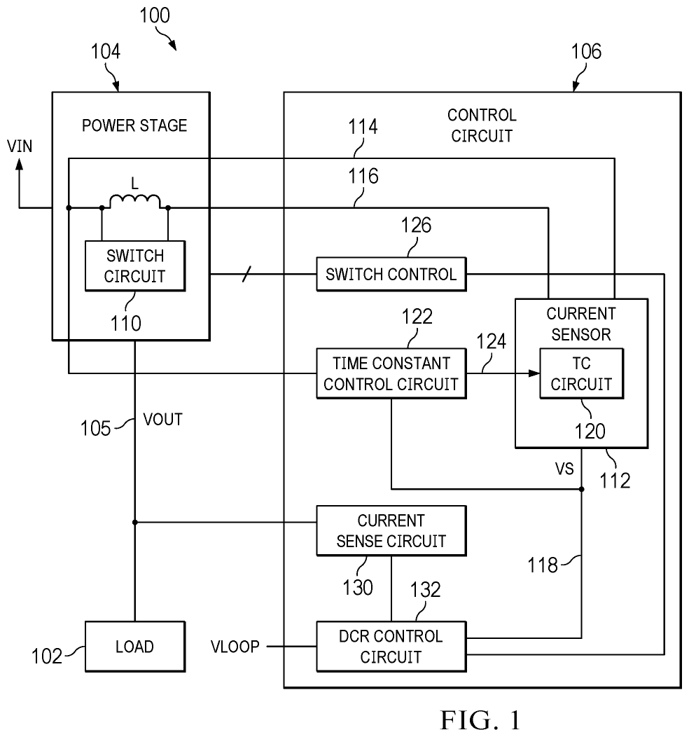

FIG. 1 is a block diagram of an example power converter 100. The power converter 100 of FIG. 1 includes an example load 102, an example power stage 104, an example control circuit 106, an example switch circuit 110, an example current sensor 112, example inputs 114, 116 (also referred to as input terminals), example outputs 118, 124 (also referred to as an output terminals), an example tunable time constant (TC) circuit 120, example time constant control circuitry 122, an example switch control circuit 126, an example average current sense circuit 130 (also referred to as an average current sense circuit), and an example direct current (DC) resistance (DCR) control circuit 132.

The power converter system 100 of FIG. 1 is configured to supply electrical power to the load 102. The power converter system 100 may be used in battery charging application, power converting applications for personal electronics, automotive application, industrial charger applications, medical equipment application, and/or any other application where DC-DC switching converters are used. In some examples, the load 102 of FIG. 1 may include one or more battery cells and the power converter may be a battery charger. Thus, the power converter 100 can be configured to deliver high current to the load 102. The power converter 100 includes a power stage 104 and a control circuit (e.g., a controller) 106. The power stage 104 has a power input coupled to a voltage source, which is configured to provide an input voltage VIN (e.g., a DC input voltage). The power stage 104 also has an output that is adapted to be coupled to the load 102.

The power stage 104 is coupled to the control circuit 106 through one or more electrical connections 105, and the power stage is configured to convert the input voltage VIN to an output voltage VOUT responsive to control signals provided by the control circuit 106. For example, the power stage 104 includes a switch circuit 110 and an inductor L 211. The switch circuit 110 includes an arrangement of one or more switch devices (e.g., transistors) coupled to terminals of the inductor L 211. The switch devices of the circuit 110 are configured to control current through the inductor L 211 responsive to the control signals to provide the output voltage VOUT to the load 102. For example, a switch control (e.g., pulse generator and driver circuitry) 126 is configured to provide the control signals to control turning on and off respective switch devices of the switch circuit 110.

The control circuit 106 includes a current sensor 112 having inputs 114 and 116 and an output 118. The current sensor inputs 114 and 116 are coupled to respective terminals of the inductor L 211. The current sensor 112 also includes a tunable time constant circuit 120, and the current sensor 112 is configured to provide a voltage signal VS at 118 representative of the current through the inductor L 211.

The time-constant control circuit 122 has inputs coupled to the input 114 of the current sensor and to the output 118 of current sensor 112. The time-constant control circuit 122 also has the output 124 coupled to the time constant circuit 120. The time-constant control circuit 122 is configured to tune the time constant circuit 120 responsive to detecting a zero crossing of the current sensor output 118 and a zero crossing of the signal at 114 representative of inductor current.

At power up, the control circuit 106 implements a calibration process to configure the time constant circuit 120. For example, during the calibration, the switch control circuit 126 provides a fixed on-time pulse to activate one or more switch devices coupled at 114, which enables current to increase in the inductor L 211 while with the other side of the inductor 211 at 116 is coupled to an electrical ground (e.g., though another switch device). The switch devices coupled at 114 can be implemented as a field effect transistor having a body diode. During the off-time of the pulse, the diode continues to conduct the inductor current, which decreases at a rate functionally related to the time constant of the inductor L 211. The voltage VS at 118 tracks the inductor current and varies according to the time-constant of the time constant circuit 120. The time-constant control circuit 122 is configured to tune the time constant circuit 120 to align the zero crossing of VS to match the zero crossing detected at 114, which is representative of the actual inductor current. In an example when the time constant circuit 120 includes an RC circuit having a variable capacitor, the time-constant control circuit 122 is configured to adjust the capacitance to perform the zero crossing alignment of VS with respect to the inductor current. The capacitance value can be set, such as by setting the value of one or more registers.

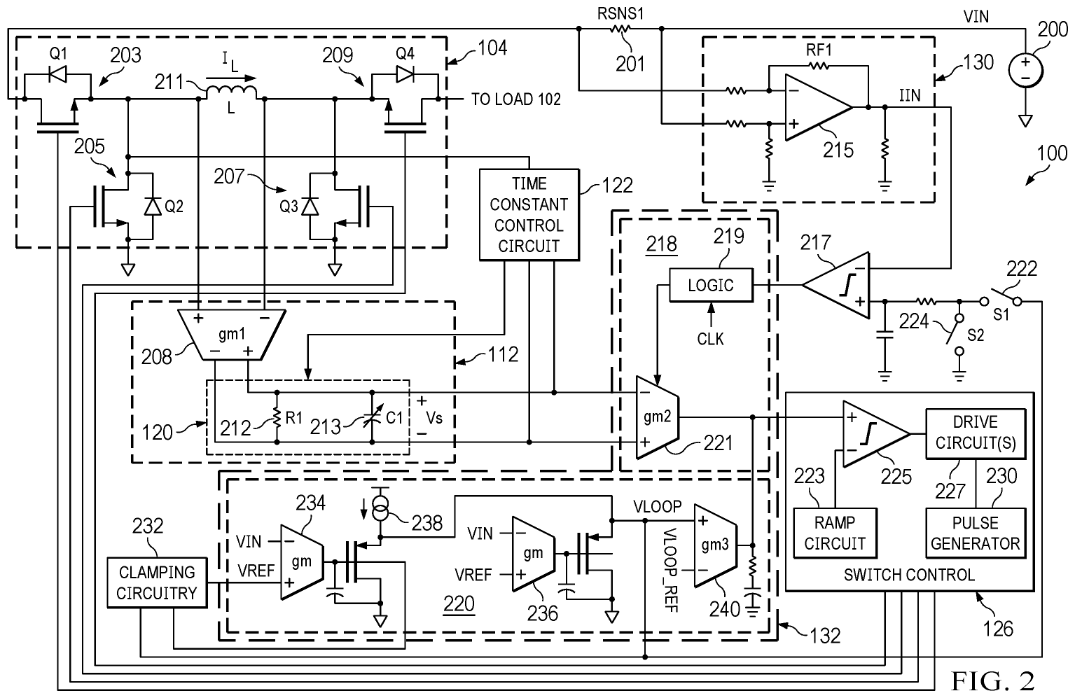

The control circuit 106 also includes the current sense circuit 130 and a DCR control circuit 132. The current sense circuit 130 can be coupled to the output or input of the power stage 104, and configured to provide a current sense signal representative of an average current through the inductor L 211. The DCR control circuit 132 has one input coupled to the output of the current sense circuit 130 and another input configured to receive a current command signal (e.g., a loop voltage (VLOOP) at the VLOOP node). As further described below in conjunction with FIG. 2, a clamping circuit can clamp the VLOOP voltage in response to a transient condition to prevent current and/or voltage overshoot. The DCR control circuit 132 may include tunable loop gain circuits (e.g., an inner loop gain circuit and an outer loop gain circuit). As further described below, the loop gain circuits can be configured to set one or more loop gains for the loop(s) responsive to a gain adjustment signal provided by the DCR control circuit 132. The DCR control circuit 132 is configured to provide the gain control signal to adjust the gain of the loop gain circuit responsive to the current sense signal and the current command signal. As described herein, the DCR control circuit 132 can operate continuously during normal operation of the power converter 100 (as part of the feedback loop of the power converter control circuit 106). The continual gain adjustments for average current feedback allows for constant loop gain in the current feedback largely independent of DCR or variations in DCR due to temperature changes. As a result, the power converter control circuit 106 can operate largely immune to changes in inductor values or parasitic board impedance. Ultimately, because the power converter 100 is configured to autonomously determine inductor properties, the user (e.g., customer) does not need to account for the choice of inductor that is used in the power converter.

FIG. 2 is a circuit diagram showing an example circuit implementing the power converter system 100 of FIG. 1. The circuit diagram of FIG. 2 includes the example power stage 104, the example control circuit 106, the example switch circuit 110, the example current sensor 112, the example inputs 114, 116 (also referred to as input terminals), the example outputs 118, 124 (also referred to as an output terminals), the example tunable time constant (TC) circuit 120, the example time constant control circuitry 122, the example switch control circuit 126, the example average current sense circuit 130, and the example direct current (DC) resistance (DCR) control circuit 132 of FIG. 1. The circuit diagram of FIG. 2 further includes an example input voltage source 200, an example input sense resistor 201, example switches 203, 205, 207, 209, an example gain stage 208 (also referred to as a fully differential amplifier), an example resistor 212, an example capacitor 213, an example amplifier 215, and example loop comparator 217, example inner loop gain circuit 218, example logic circuitry 219, example outer loop gain circuit 220, example gain stage 221, example switches 222, 224, an example ramp circuit 223, an example pulse width modulator (PWM) comparator 225, example drive circuit(s) 227, an example pulse generator 230, example clamping circuitry 232, example gain stages 234, 236, 240, and an example current source 238.

As shown, the power converter system 100 includes a power stage 104, which includes the inductor L 211 and switches Q1, Q2, Q3 and Q4 203, 205, 207, 209 (e.g., which make up the switch circuit 110 of FIG. 1). The power stage 104 includes an arrangement of switches (e.g., transistors) Q1, Q2, Q3 and Q4 203, 205, 207, 209, each having a body diode coupled between its respective source and drain. The switches Q1, Q2, Q3 and Q4 203, 205, 207, 209 may be transistors. For example, in FIG. 2 the switches Q1, Q2, Q3 and Q4 203, 205, 207, 209 are N-channel metal oxide semiconductor field effect transistors (NMOS FETs) configured as an H-bridge. However, other types of transistors and/or configuration of transistors may be used. As shown in FIG. 2, Q1 203 has a source coupled to the inductor L 211 and a drain coupled to the voltage source 200. The voltage source 200 is configured to provide a DC input voltage (VIN). Q2 205 has a drain coupled to the source of Q1 203 and a source coupled to ground. Q3 207 has a drain coupled to the other terminal of the inductor L 211 and source coupled to ground. The gates of Q1, Q2, Q3, Q4 203, 205, 207, 209 are coupled to a switch control circuit 126 through drive circuitry 227, which includes respective gate drivers of the switch control circuit 126. The switch control circuit 126 is configured to activate and deactivate the respective switch devices Q1, Q2, Q3 and Q4 203, 205, 207, 209 to control current through the inductor L 211. The drain of Q4 209 can be coupled to a load, such as a battery (not shown) to charge the battery. In other examples, different numbers and types of switch devices can be configured to supply current to the inductor L 211 according to application requirements.

The time constant control circuit 122 includes the current sensor 112 coupled to terminals of the inductor L 211. The current sensor 112 has inputs coupled to terminals of the inductor L 211, and is configured to provide an output signal, shown as VS, which is representative of inductor current IL. In the example of FIG. 2, the current sensor 112 includes a gain stage 208 having two input terminals (e.g., an inverting input terminal and a non-inverting input terminal) coupled to the respective terminals of the inductor L 211. The gain stage has two output terminals (e.g., an inverting output terminal and a non-inverting output terminal) coupled to the time constant circuit 120. The gain stage 208 is configured to have a gain, shown as gm1, and provides an amplified output across differential outputs of the gain stage 208 representative of a measured voltage across the inductor L 211. As described herein, the current sensor 112 is configured to provide an output representative of inductor current responsive to the measured voltage across the differential outputs (e.g., corresponding to the VS voltage).

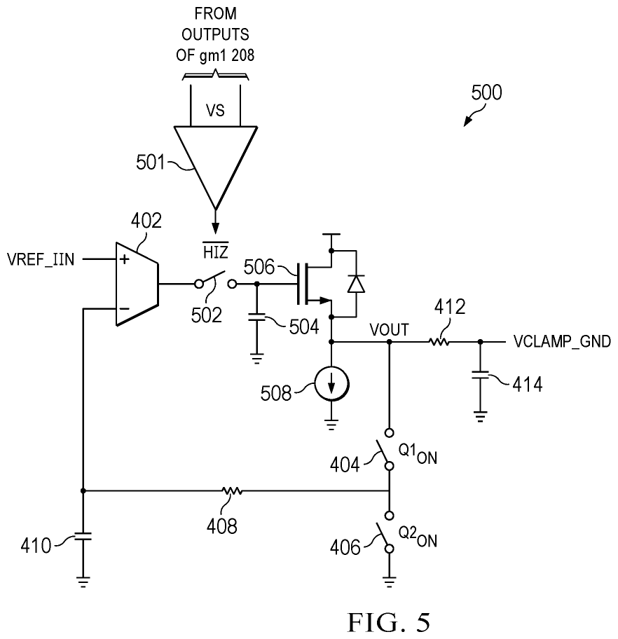

In one example, the time constant circuit 120 is an active circuit, such as an RC filter having a variable capacitor C1 213 and resistor R1 212 coupled in parallel to respective outputs of the gain stage 208. In other examples, different types of active circuits can be used. As described herein, the time constant circuit 120 is used to determine the time constant of the inductor L 211. The current sensor 112 has an output (e.g., shown as a differential output) coupled to an input of the gain stage 221 of the inner loop gain circuit 218. In some examples, the differential outputs of the current sensor 112 are coupled to a comparator (e.g., a zero crossing detection circuit), as shown in FIG. 5. The voltage difference between the differential outputs of the current sensor 112 is herein referred to as an output signal VS, representative of current through the inductor L 211. Thus, the measured voltage VS (e.g., representative of current through L) can provide an estimate of the current through the inductor 211, and the RC filter can be tuned so the sensed current from VS matches actual inductor current. For example, the sensed voltage VS can be represented as follows:

$$Vs = {I}_{L} {R}_{DCR} \frac{gm 1 * {R}_{2} ( s \frac{L}{{R}_{DCR}} + 1 )}{( {sR}_{2} {C}_{1} + 1 )} \qquad ( Equation 1 )$$

The power converter 100 also includes time constant control circuit 122 and DCR control circuit 132. As described herein, the circuits 122 and 132 are configured to determine respective inductor properties and to tune one or more respective feedback loops responsive to the determined inductor properties. In an example, the time constant control circuit 122 is enabled (e.g., by a system state machine) to activate during a calibration phase (e.g., at power up). When enabled, the time constant control circuit 122 is configured to tune a time constant circuit 120 (e.g., an RC filter having a variable capacitor C1 213) to match the time constant of the inductor L 211. For example, the time constant control circuit 122 can be configured to implement such tuning by matching the zero crossing of VS to the zero crossing of the inductor current (e.g., as detected across the body diode of Q2 205). In one example, the time constant control circuit 122 is configured to perform such tuning by adjusting the capacitance value of C1 213 and setting the value of C1 213 responsive to detecting when the zero crossings match. After the zero crossing match condition has been detected and the value of C1 213 is tuned to maintain the match condition, the respective tuned value of C1 213 can remain fixed during operation of the power converter 100. Alternatively, the time constant control circuit 122 may be re-activated to determine the inductor time constant, such as responsive to a reset or other condition in which it would be desirable to recalibrate the time constant circuit 120.

In the example of FIG. 2, the DCR control circuit 132 has an inner loop gain circuit 218 and an outer loop gain circuit 220. The inner loop gain circuit 218 is coupled to the current sensor 112, which is coupled to terminals of the inductor L 211 of the power stage 104. As described herein, the current sensor 112 includes a time constant circuit configured to set a time constant for the inner loop gain circuit 218. Accordingly, the current sensor 112 is configured to provide a feedback signal representative of sensed inductor current, shown as the voltage VS. The inner loop gain circuit 218 has an output coupled to an input of a PWM comparator 225. The inner loop gain circuit 218 also includes inputs coupled to respective outputs of a loop comparator 217 and the outer loop gain circuit 220. The inner loop gain circuit 218 is also configured to implement a gain (gm2) responsive to signals received at its inputs.

The inner gain loop circuit 218 also includes a gain stage 221 having a control input coupled to an output of the logic circuit 219. The logic circuit 219 is configured to generate a gain adjust signal to tune a gain (gm2) of the gain stage 221. In an example, the logic circuit 219 is implemented as a counter to increment or decrement a count value responsive to the comparator output and a clock signal (CLK), in which the count value specifies a gain value. The gain stage 221 is configured to apply a variable gain (gm2) with respect to the input signal VS that is adjusted responsive to the gain adjust signal (e.g., a digital value) provided by the logic circuit 219. In one example, the gain stage 221 can include an arrangement of resistor segments and switches that are coupled respectively into and out of the gain stage 221 responsive to the gain adjust signal. In other examples, different configurations of variable gain stage can be implemented for gain stage 221. Accordingly, the gain stage 221 is configured to implement its variable gain and provide an output signal (e.g., a voltage) to a non-inverting input of the PWM comparator 225 responsive to VS and the gain adjust signal. A ramp generator circuit 223 has an output coupled to the inverting input of the PWM comparator 225. The PWM comparator 225 is configured to provide pulses (e.g., through gate drivers) to control respective switches Q1, Q2, Q3 and Q4 203, 205, 207, 209 of switch circuit 110 for supplying current to the inductor 211.

The outer loop gain circuit 220 of FIG. 2 has an input terminal configured to receive a reference voltage signal VREF at a reference voltage (VREF) terminal, which is representative of user-selected converter regulation operating parameters. For example, VREF may be a voltage that corresponds to a maximum amount of input current that can be pulled from the voltage source 200. The outer loop gain circuit 220 has an output coupled to an input of the loop comparator 217. The outer loop gain circuit 220 is configured to provide the input a loop current command signal VLOOP having a value specifying a desired current command for the inductor current. The outer loop gain circuit 220, which has a gain (gm3) set responsive to VLOOP, is configured to set the reference for the inner loop. The outer loop gain circuit 220 also has an output terminal coupled to another input of the inner loop gain circuit 218. For example, the outer loop gain circuit 220 is configured to provide an output signal (e.g., a voltage), shown at 610, to the inner loop gain circuit 218 responsive to VLOOP and according to gain gm3. The value of VLOOP can vary during operation and power requirements of the power converter. Thus, the value of the output at 610 likewise can vary during operation responsive to changes in VLOOP.

The outer loop gain circuit 220 includes gain stages 234, 236 each having an input coupled to a reference voltage, which may be set by a user (e.g., by setting a digital value in a register and/or using an external resistor). The regulation point further can be set depending on the type of regulation mode (e.g., input current mode, output current mode, input voltage mode, or output voltage mode). The gain stages 234, 236 are configured to provide VLOOP voltage to the gain stage 240 and/or to the non-inverting terminal of the comparator 217 (e.g., via the switch 222) based on the input VREF via the VLOOP node (e.g., an output node or output terminal of the outer loop gain circuitry 220). The VLOOP node is also coupled to an input of another gain stage 240, shown as having a gain gm3. An output terminal of the gain stage 240 is coupled to the output terminal of the gain stage 221 in the inner loop gain circuit 218 and an input terminal of the switch control circuit 126.

The VLOOP node is also coupled to the non-inverting input of comparator 217 via a switch circuit. The switch circuit can include a first switch S1 222 coupled in series with a resistor, and a second switch S2 224 coupled between the resistor on the opposite side of the capacitor and ground. The first and second switches S1 222 and S2 224 can be controlled mutually exclusively between on and off states (e.g., by logic not shown) depending the mode of the converter and duty cycle. For example, the switches S1 222 and S2 224 are controlled by the boost mode control signals, which are the same signals that control the switch Q4 209 and the switch Q3 207, respectively. In such an example, the switch S1 222 is on when the switch Q4 209 is on, and S2 224 is on when Q3 207 is on. This results in an input to the comparator 217 that is VLOOP*(1-D), which accounts for the inductor current being higher than the output current when operating in boost mode. Thus, the switch circuit is configured to provide a filtered, duty-cycle modulated version of VLOOP to the non-inverting input of the comparator 217. The comparator 217 has an output coupled to an input of a logic circuit 219 of the inner gain loop circuit 218. The comparator 217 is configured to compare the input current (IIN) and VLOOP signals and provide an output signal indicative of whether the loop gain is too high or too low responsive to IIN and VLOOP signals. Although examples disclosed herein utilize an input current (IIN), a battery current (IBAT) can be utilized when the battery current is a function of the inductor current.

The loop comparator 217 is a circuit that has a first input configured to receive VLOOP from the outer loop gain circuit 220 (e.g., via the switches 222, 224). The loop comparator 217 also has a second input coupled to an output of an average current sense circuit 130. The current sense circuit 130 includes sense resistor RSNS1 201 (e.g., RS2≈5 mΩ) coupled between the drain of Q1 203 and an output of the voltage source 200, which supplies VIN to the power converter 100. Respective terminals of RSNS1 201 are coupled to inputs of the amplifier 215 through respective resistors. The average current sense circuit 130 includes a feedback resistor RF2 coupled between an output 902 of the amplifier 215 and its inverting input. Accordingly, the amplifier 215 is configured to provide an output signal IIN at the output of the amplifier 215, such as a voltage responsive to the voltage potential across RSNS1 201. The amplifier 215 is further configured to provide an output signal IIN at the output of the amplifier 215, such as a voltage responsive to the voltage potential across the Rsens1 resistor 201 having a value representative of the input current. Accordingly, the IIN node corresponds to the IIN voltage output by the amplifier 215 that is representative of the input current that is a function of the average inductor current. Although the example current sense circuit 130 determines an input current, the current sense circuit 130 could be coupled to different nodes of the circuit to measure output current, input voltage, output voltage, etc.

The loop comparator 217 is configured to provide a gain adjust signal to the inner loop gain circuit responsive to VLOOP and IIN. The inner loop gain circuit 218 is thus configured to implement gain adjustments responsive to the gain adjust signal. The inner loop gain circuit 218 is further configured to provide an output current command signal (e.g., a voltage) to the input of the PWM comparator 225 responsive to the gain adjust signal and the output 610 provided by the outer loop gain circuit 220. As a further example, in steady state operation, it can be shown that the sensed voltage across the inductor L 211 (VS) can be expressed as follows:

Vs=IL*R_{DCR} (Equation 2),

which can be rewritten as

gm2*IL*R_{DCR}=gm3*VLOOP (Equation 3),
where I̅L̅ is the average inductor current, and
gm2 and gm3 are representative of gains of the respective inner and outer loop gain circuits 218 and 220.
   Solving for VLOOP, the above equation can further be rewritten as:

$$VLOOP = \frac{gm 2}{gm 3} * I \overline{L} * {R}_{DCR} \qquad ( Equation 4 )$$

Thus, the loop comparator 217 is configured to provide the gain adjust signal to continually adjust the gain gm2 of the inner loop gain circuit 218 to match the actual battery current to the desired current. In an additional or alternative example, the loop comparator 217 could be configured to provide the gain adjust signal to continually adjust the gain gm3 of the outer loop gain circuit 220. As a result, the DCR control circuit 132 is configured to determine a value of DCR and to thereby compensate for differences in the DCR of the inductor 211 (R_{DCR}). This form of compensation, which can be performed during operation, is referred to herein as adaptive DCR optimization.

The DCR control circuit 132 is configured to determine the DCR of the inductor L 211 and to adjust the gain of an internal feedback current loop to match the determined DCR. For example, the loop comparator 217 has inputs coupled to an output of an average current sense circuit 130 and to an outer loop gain circuit 220. The average current sense circuit 130 is coupled to an output of the converter (e.g., drain of Q1 203) and is configured to measure current supplied to the load 102. Thus, the comparator 217 is configured to receive IIN, which can be a voltage value representative of the average input current, at the inverting input of the comparator. The non-inverting input of the comparator 217 is configured to receive a signal responsive to VLOOP, which is representative of desired inductor current. The comparator 217 is configured to compare IIN and a filtered VLOOP and provide a comparator output signal to logic circuit 219. The logic circuit 219 is configured to generate a gain adjust signal and adjust the gain of gain stage 221 responsive to the comparator output. The gain adjustments can be implemented continually, such as every clock cycle responsive to IIN and VLOOP. The period of the clock cycle can be set (e.g., responsive to a register value) to configure the frequency in which the gain is adjusted to compensate for changes in DCR of the inductor 211.

The gain stage 221 is configured to provide a gain adjusted version of VS to a PWM comparator 225, which is part of switch control circuit 126. The switch control circuit 126 also includes ramp generator circuit 223, pulse generator 230 and drive circuitry 227. The ramp generator circuit 223 has an output coupled to the inverting input of the PWM comparator 225. The PWM comparator 225 is configured to provide pulses to a drive circuit to control respective switches Q1, Q2, Q3 and Q4 203, 205, 207, 209 of switch circuit for supplying current to the inductor L 211. By tuning the time constant circuit 120 and adjusting gain to match respective inductor properties, as described herein, the power converter is configured to adjust the loop dynamics for changes in the DCR, such as may occur due to temperature and aging. The approach described herein for determining inductor properties can be used for various types of power converters, such as a buck, boost, buck-boost or other converter type, which can vary according to application requirements.

In some examples, the switch control circuit 126 is configured to operate the power converter in a calibration phase, such as can be implemented to determine the time constant of the inductor 211 at power up or reset of the power converter. The switch control circuit 126 includes a pulse generator 230 configured to supply control pulses having a duty cycle. In an example, the pulse generator 230 includes a pulse width modulation (PWM) generator configured to provide the signal control pulses responsive to a ramp signal and a reference signal. During the calibration phase, the switch control circuit 126 controls the pulse generator 230 to supply the pulses to the gates of Q1 and Q3 203, 207 with a fixed on time while Q2 and Q4 205, 209 are held off. This allows inductor current to increase during the on time while Q1 and Q3 203, 207 are both on. When the switch control circuit 126 turns off Q1 203 and keeps Q3 207 on, while Q2 205 and Q4 209 remain off, inductor current is pulled through the diode of Q2 205, through inductor L 211 and through Q3 207, shown as current path toff. The inductor current during the off interval (toff) decreases at a rate functionally related to the time constant of the inductor L 211 until the diode of Q2 205 ceases conduction and turns off. During such calibration, a zero crossing detected at the first current terminal (e.g., the drain terminal) of the transistor 205 is representative of when the current through the diode of Q2 205 ceases conduction. The logic circuit is configured to control the value of the register to tune the time constant of the circuit 120 so that VS measured at the output of the current sensor 112 and the inductor current measured at the first current terminal (e.g., the drain terminal) of the transistor 205 have simultaneous zero crossings. In one example, the logic is configured to increment the register value by a counter value (e.g., from a minimum to a maximum value or from a maximum to a minimum value). In another example, the logic is configured to implement a binary search for tuning the time constant circuit to achieve a match in zero crossings.

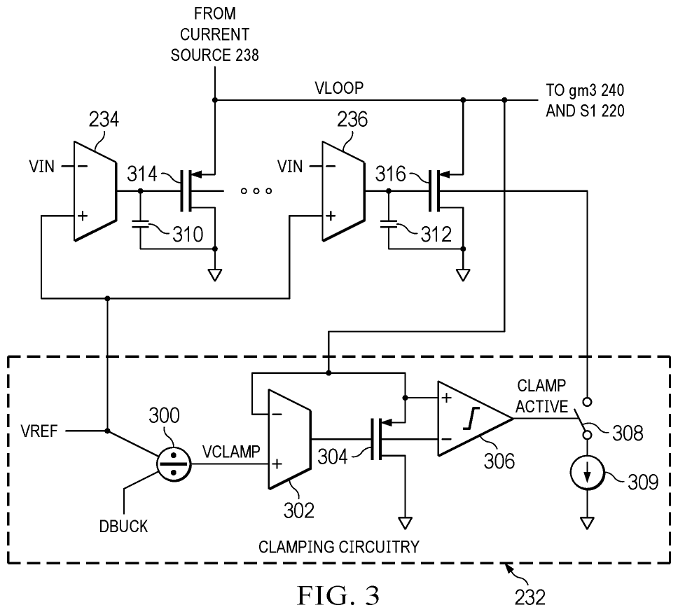

The example clamping circuitry 232 of FIG. 2 clamps the VLOOP voltage to a threshold voltage (e.g., a voltage at or above the VLOOP REF voltage provided by a user and/or manufacturer) to reduce current and/or voltage overshoot caused by a transient condition (e.g., a sudden change in the load 102 which causes the current and/or voltage to reach a threshold). Because the inner current loop is well defined (e.g., average IL/VLOOP), the clamping circuitry 232 can leverage the inner current loop, the duty cycle of the control of the switches Q1, Q2, Q3 and Q4 203, 205, 207, 209, and the desired input current limit (VREF) to generate a clamp on the inner-loop control signal (VLOOP). Clamping the VLOOP signal will limit the maximum requested inductor current to a level that will limit the peak input current to a desired level. The clamping circuitry 232 provides fast and/or responsive overshoot protection in response to a transient condition. The clamping circuitry 232 is further described below in conjunction with FIG. 3.

Although the example power converter circuitry 100 of FIGS. 1 and/or 2 provide a particular structure, examples described herein van be used to clamp voltage and/or current in any type of power converter. For example, there may be additional and/or alternative ways to sense inductor current and/or additional currents and/or voltages to clamp based on the sensed inductor current. Described examples may be used in a system were the ratio of the loop voltage and inductor current (IL) (e.g., VLOOP/IL) is controlled and/or known. For example, described examples may utilize direct inductor current measured via a sense resistor may be included in series with the inductor or directly sensing inductor current with power switches.

FIG. 3 is a circuit diagram illustrating an example implementation of the clamping circuitry 232 of FIG. 2. FIG. 3 includes the gain stages 234, 236 of FIG. 2. The clamping circuitry 232 of FIG. 3 includes example divide-by-duty cycle circuitry 300, an example gain stage 302, an example transistor 304, an example comparator 306, an example switch 308, and an example current source 309. FIG. 3 further includes example capacitors 310, 312, and example transistors 314, 316.

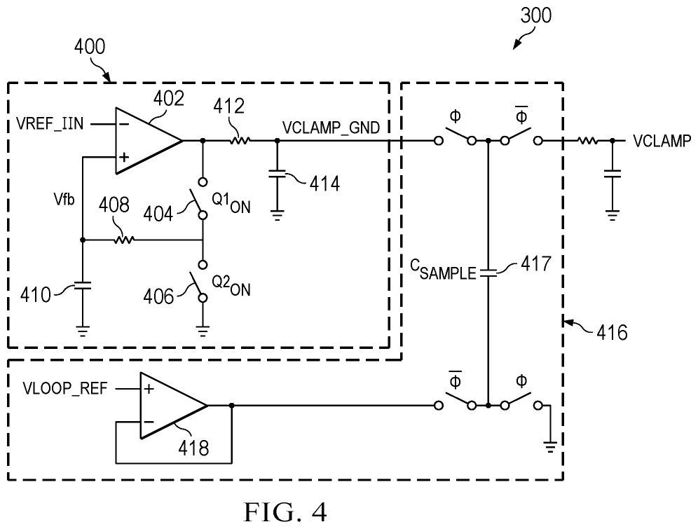

The divide-by-duty cycle circuitry 300 of FIG. 3 increases the gain of the VREF voltage by modulating the VREF voltage with the duty cycle used to control one or more of the switches Q1, Q2, Q3 and Q4 203, 205 (e.g., represented by the DBUCK input), 207, 209 of FIG. 2 to translate the input current (IIN) to the inductor current (IL) and generate a VCLAMP voltage. For example, if the input voltage of the voltage source 200 is less than the output voltage (e.g., the power converter 100 is operating as a boost converter), IIN equals IL. If the input voltage of the voltage source 200 is more than the output voltage (e.g., the power converter is operating as a buck converter), IL will equal the output current (IOUT) which equals IIN/DBUCK. The VCLAMP voltage represents the voltage at the VLOOP node should be clamped. divide-by-duty cycle circuitry 300 outputs the VCLAMP voltage to the non-inverting terminal of the gain stage 302. The divide-by-duty cycle circuitry 300 is further described below in conjunction with FIGS. 4 and/or 5.

The gain stage 302 of FIG. 3 is an amplifier that amplifies the difference between the non-inverting input terminal (+) and the inverting input terminal (−). The non-inverting input terminal of the gain stage 302 is coupled to the output of the divide-by-duty cycle circuitry 300 (e.g., VCLAMP) and the inverting input terminal of the gain stage 302 is coupled to the VLOOP node of the outer loop gain circuit 220. Accordingly, the gain stage 302 amplifies the difference between VCLAMP voltage and the VLOOP voltage so that when VLOOP goes above VCLAMP, the output of the gain stage 302 will be low (e.g., 0 volts or negative voltage), thereby causing the transistor 304 to clamp the VLOOP voltage, as further described below. In some examples an offset voltage (VOFF) may be applied to the gain stage 302 to apply a voltage offset to the differential comparison of the gain stage 302. In this manner, the VLOOP can be clamped slightly above the user-selected maximum current level to ensure that the outer loop gain circuit 220 maintains regulation during non-transient conditions (e.g., to avoid sub-regulating before the outer loop regulation takes over regulation of one or more currents and/or voltages). The output terminal of the gain stage 302 is coupled to the control terminal (e.g., the gate terminal) of the transistor 304 to control the transistor 304.

The example transistor 304 of FIG. 3 operates as a clamp to clamp the VLOOP voltage when enabled. The transistor 304 is a P-channel MOSFET (PMOS or PFET). In some examples, the transistor 304 may be another type of transistor. For example, the transistor 304 may be a NFET if the terminals of the gain stage 302 are switched (e.g., the VCLAMP is coupled to the inverting terminal and the VLOOP is coupled to the non-inverting terminal). The transistor 304 includes a control terminal (e.g., a gate terminal), a first current terminal (e.g., a source terminal), and a second current terminal (e.g., a drain terminal). The control terminal is coupled to the output of the gain stage 302. In this manner, if the gain stage 302 outputs a high voltage, the transistor 304 is disabled (e.g., so that there is an open circuit between the current terminals) to allow the outer loop gain circuit 220 to maintain control of the inductor and/or input current. If the gain stage 302 outputs a low voltage, the transistor 304 is enabled (e.g., so that there is a close circuit between the current terminals), thereby causing the transistor 304 to clamp the VLOOP voltage. The clamping circuitry 232 clamps the VLOOP voltage which causes the switch control circuit 126 to clamp the inductor current (IL) through the inductor 211. Because the input current is a function of the inductor current, clamping the inductor current clamps the input current to avoid and/or reduce input current overshoot.

The clamping circuitry 232 further includes the example comparator 306, the switch 308, and the current source 309 to quickly transition back to outer loop regulation of the one or more currents and/or voltage from the clamping regulation. The comparator 306 determines when the clamping regulation is active (e.g., when the transistor 304 clamps the VLOOP voltage to regulate one or more currents and/or voltages) or not active (e.g., when the outer loop circuitry regulates the one or more currents and/or voltages). The comparator 306 includes a first input terminal (e.g., a non-inverting input terminal), a second input terminal (e.g., an inverting input terminal), and an output terminal. The first input terminal is coupled to the VLOOP node. The second input terminal is coupled to the output of the gain stage 302 and the control terminal of the transistor 304. The output terminal is coupled to the switch 308. The comparator 306 outputs a first voltage (e.g., a low voltage, 0 V, etc.) when the voltage at the first input (VLOOP) is higher than the voltage at the second input terminal (e.g., the voltage output by the gain stage 302 and/or at the control terminal of the transistor 304). Accordingly, the comparator 306 outputs the first voltage when the clamp regulation is active (e.g., the transistor 304 is enabled to clamp the VLOOP voltage). The comparator 306 outputs a second voltage (e.g., a high voltage, 3.3 V, etc.) when the voltage at the first input terminal (VLOOP) is less than or equal to the voltage at the second input terminal. Accordingly, the comparator 306 outputs the second voltage when the clamp regulation is not active (e.g., the transistor 304 is disabled and the outer loop gain circuit 220 is regulating the one or more currents and/or voltages). The output of the comparator 306 is used to enable and/or disabled the switch 308.

The switch 308 of FIG. 3 is enabled when the clamp is active (e.g., the transistor 304 is clamping the VLOOP voltage) to shorten the amount of time to transition from the clamp regulating the one or more currents and/or voltages to the outer loop regulating the one or more currents and/or voltage after a transient condition occurs. Additionally, the switch 308 is disabled when the clamp is not active. The switch 308 may be a transistor (e.g., a MOSFET, such as a PFET) and/or any other type of switch. When the comparator 306 outputs the first voltage corresponding to clamp regulation being active, the switch 308 is enabled to create a short between the capacitors 310, 312 and the current source 309. When the comparator 306 outputs the second voltage corresponding to the clamp regulation being not active (e.g., when outer loop regulation is active), the switch 308 is disabled to create an open circuit between the capacitors 310, 312 and the current source 309. Thus, when the clamping regulation is active and the switch 308 is enabled, the current source 309 pulls down (e.g., slews) the capacitors 310, 312 to ground to quickly transition back to outer loop regulation. In this manner, when a transient condition occurs, the clamping circuitry 232 can activate to quickly mitigate current and/or voltage overshoot and the switch 308 can enable to quickly transition back to the more accurate current and/or voltage regulation provided by the outer loop gain circuit 220.

FIG. 4 is an example circuit implementation of the divide-by-duty cycle circuitry 300 of FIG. 3. The divide-by-duty cycle circuitry 300 includes example modulation circuitry 400 and the example level shifting circuitry 416. The modulation circuitry 400 includes an example amplifier 402, example switches 404, 406, example capacitors 410, 414, and an example resistor 412. The example level shifting circuitry 416 includes an example sample capacitor 417 and an example buffer 418.

The modulation circuitry 400 modulates the reference voltage selected by a user and/or manufacturer with the duty cycle of the switches Q1, Q2, Q3 and Q4 203, 205, 207, 209 used to regulate the output voltage to generate the clamp voltage with respect to ground. The modulation circuitry 400 includes the amplifier 402. The amplifier 402 may be an operational amplifier that amplifies a voltage difference between the two input terminals. The amplifier 402 includes a first input terminal (e.g., a non-inverting input terminal) that is coupled to a source that provides the VREF voltage. As described above, the VREF voltage is a voltage that the user and/or manufacturer selects that corresponds to a maximum current and/or voltage that the outer loop gain circuit 220 and/or the clamping circuitry 232 regulates. The amplifier 402 further includes a second input terminal (e.g., an inverting input terminal) that is coupled to a feedback node (Vfb) that connects to the capacitor 410 and the resistor 408. The amplifier 402 also includes an output terminal coupled to the switch 404 and the resistor 412.

The switches 404, 406 of FIG. 2 are enabled and/or disabled by the switch control 126 when the respective switches Q1, Q2 203, 205 are enabled and/or disabled. For example, the switch 404 is enabled when the switch Q1 203 is enabled and the switch 404 is disabled when the switch Q1 203 is disabled. Likewise, the switch 406 is enabled when the switch Q2 205 is enabled and the switch 406 is disabled when the switch Q2 205 is disabled. In some examples, the switches 404, 406 may correspond to the operation of the switches Q3, Q4 207, 209. When the example switch 404 is enabled and the example switch 406 is disabled, the amplifier 402 is structured to provide a feedback voltage to the second input terminal of the amplifier 402 and charge the capacitor 410 (e.g., to increase the feedback voltage (Vfb)). When the example switch 404 is disabled and the example switch 406 is enabled, the capacitor 410 discharges toward ground, thereby lowering the feedback voltage (Vfb). In this manner, the amplifier 402 modulates the Vref voltage based on the duty cycle of the switches Q1, Q2 203, 205 with respect to ground to generate the VCLAMP_GND voltage at the VCLAMP_GND node. The example capacitor 414 filters out high frequency noise at the output of the amplifier 402.

The output of the modulation circuitry 400 of FIG. 4 buffers and filters the VREF voltage with a duty cycle modulated feedback. The output of the amplifier 402 of the modulation circuitry 400 sets the voltage for the inductor clamp, which is represented as follows:

$${V}_{REF \_ IIN} = 〈 {V}_{FB} 〉 = \frac{{V}_{OUT} \cdot {t}_{Q 1} + 0 \cdot {t}_{Q 2}}{{t}_{Q 1} + {t}_{Q 2}} = {V}_{OUT} \cdot {D}_{BUCK} \qquad ( Equation 5 )$$

$${V}_{CLAMP \_ GND} = 〈 {V}_{OUT} 〉 = \frac{{V}_{REF \_ IIN}}{{D}_{BUCK}} \qquad ( Equation 6 )$$

The level shifting circuitry 416 of FIG. 4 level shifts the ground-referenced VCLAMP_GND voltage by an internal reference voltage for setting common-mode range (e.g., a VLOOP_REF voltage). For example, subsequent circuitry may not be referenced to ground. Accordingly, the level shifting circuitry 416 shifts the ground-referenced VCLAMP_GND voltage to a VCLAMP voltage that is reference based on an internal reference for setting common-mode range for subsequent circuitry. The level shifting circuitry 416 includes the example sampling capacitor 417 to sample the internal reference VLOOP_REF voltage, which is output from the example buffer 418. The switches 4 are toggled on and off (e.g., when the switch § is on the switch c is off and vice versa), so that the VLOOP_REF voltage output by the buffer 418 and stored in the sample capacitor 417 is used to level up the ground referenced VCLAMP_GND voltage to the VCLAMP voltage. The buffer 418 of FIG. 4 is an operational amplifier connected as a buffer circuit. However, other circuitry can be used to implement the buffer 418.

FIG. 5 illustrates an example alternative circuit implementation 500 of the divide-by-duty cycle circuitry 300 of FIG. 3 that facilitates discontinuation operation (e.g., such as discontinuous conduction mode or pulse frequency modulation) when both switches Q1 203, Q2 205 are off (herein referred to as HIZ mode). The circuitry 500 of FIG. 5 includes the amplifier 402, the switches 404, 406, the resistors 408, 412, and the capacitors 410, 414 of FIG. 4. The circuitry 500 further includes an example comparator 501, an example switch 502, an example capacitor 504, an example transistor 506, and an example current source 508.

During HIZ mode, both the switches Q1, Q2 203, 205 are off. In some examples the high Z mode occurs when the inductor current is zero or negative. Accordingly, the comparator 501 compares the outputs of the gain stage gm1 208 to determine when a zero crossing signal has occurred (e.g., indicating that the inductor current is zero and/or negative). Thus, when the inductor current is positive (e.g., non HIZ mode), the comparator 501 determines that the inductor current is positive and outputs a first signal (e.g., a logic low, 0 V, etc.). Additionally, when the inductor current is zero or negative (e.g., HIZ mode), the comparator 501 determines that the inductor current is zero or negative and outputs a second signal (e.g., a high low, 3.3 V, etc.). The output of the comparator 501 is coupled to the switch 502 to control whether the switch 502 is enabled (e.g., to create a short) or disabled (e.g., to create an open circuit). In some examples, alternative and/or additional circuitry could be implemented to determine when HIZ mode is active.

The switch 502 of FIG. 5 enables or disables based on the output of the comparator 501. If the comparator 501 outputs the first signal, the switch 502 becomes enabled and if the comparator 501 outputs the second signal, the switch 502 becomes disabled. The switch 502 may be implemented by a transistor (e.g., a MOSFET) and/or any other switch. When the switch 502 is disabled, the output of the amplifier 402 is decoupled from the VCLAMP_GND node to not actively drive the VCLAMP voltage. When the switch 502 is enabled, the amplifier 402 drives the VCLAMP voltage as described above in conjunction with FIG. 4.

The example capacitor 504 stores that last value output by the amplifier 402 prior to the switch 502 decoupling the output of the amplifier 402 from the VCLAMP output. For example, if the amplifier 402 is outputting 0 V when the switch 502 disables, the capacitor 504 will store and output 0 V to the control terminal of the transistor 506. If the amplifier 402 is outputting 3.3 V when the switch 502 disables, the capacitor 504 will store and output 3.3 V.

The transistor 506 and the current source 508 of FIG. 5 are configured to operate as a source follower (also referred to as a common drain, a voltage, buffer, etc.). Accordingly, the voltage at the second current terminal (e.g., the source terminal) (e.g., the VOUT node) of the transistor 506 is approximately equal to the voltage at the current (e.g., gate) terminal of the transistor 506. Additionally, the input impedance is very high (e.g., infinite), so that the capacitor 504 operates as a sample and hold circuit (e.g., where the voltage at the output of the amplifier 402 is sampled and held until the switch 502 is enabled. The current source 508 may be implemented by a resistor. The circuitry 500 operates as a sample and hold source follower to ensure that when HIZ mode ends, the output of the amplifier 402 has not changed from what it was when HIZ mode began.

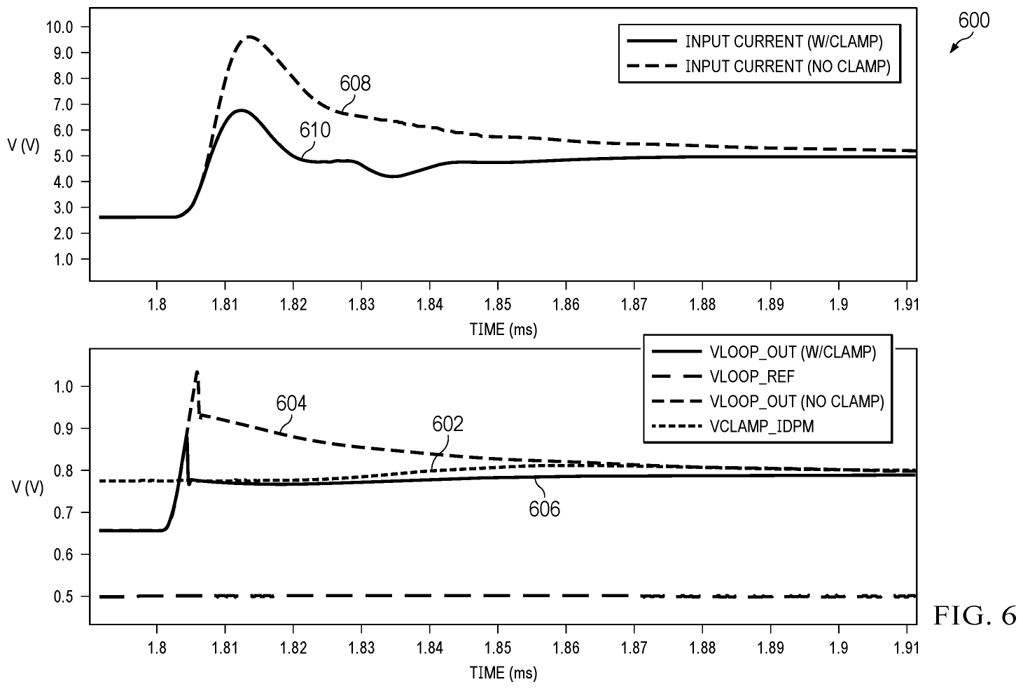

FIG. 6 is an example timing diagram 600 illustrating a comparison of (a) a response to a transient condition with a power regulator that does not include the clamping circuitry 232 of FIGS. 2 and/or 3 and (b) a response to the transient condition with the power regulator 100 described herein with the clamping circuitry 232. The example timing diagram 600 includes an example VCLAMP voltage plot 602, an example VLOOP voltage plot without clamp 604, an example VLOOP voltage plot with clamp 606, an example input current plot without clamp 608, and an example input current plot with clamp 610. Although the plots are shown at particular voltage and/or currents, the plots may be any current and/or voltage level based on the Vref, load conditions, etc.

In FIG. 6, the VCLAMP voltage plot 602, the VLOOP voltage plot with clamp 505, and the input current plot with clamp 610 corresponds to currents and/or voltages corresponding to the power converter 100 described herein with the clamping circuitry. The VLOOP voltage plot without clamp 602 and the input current plot without clamp 608 correspond to a power converter that does not have the clamping circuitry disclosed herein. In FIG. 6 the input current of the plots 608, 610 is originally at around 3.7 Amps when a transient even occurs, thereby causing the input currents to increase. The example VLOOP plot voltages 604, 606 likewise increase in response to the transient event. However, the clamping circuitry 232 clamps the VLOOP plot voltage 606 when the VLOOP plot voltage 606 goes above VCLAMP voltage plot 602. Accordingly, the VLOOP plot voltage 606 rises from around 0.65 Volts to a maximum of around 0.9 Volts before setting near the VCLAMP voltage plot 602 at around 0.79 Volts. The VLOOP plot voltage 604, however, rises to a maximum of around 1.3 Volts before setting near the VCLAMP voltage plot 602. As described herein, clamping the VCLAMP voltage clamps the inductor current which, in turn, clamps the input current. Accordingly, by clamping the VLOOP voltage, the maximum input current illustrated in the input current plot 610 is limited to around 6.5 Amps, while the maximum input current illustrated in the input current plot 608 is limited to around 10 Amps. Accordingly, the clamping circuitry reduces overshoot from 5 Amps of overshoot (e.g., 10 Amps minus the 5 Amp input current after settling from the transient condition) to 1.5 Amps of overshoot (e.g., 8.5 Amps input current after settling from the transient condition).

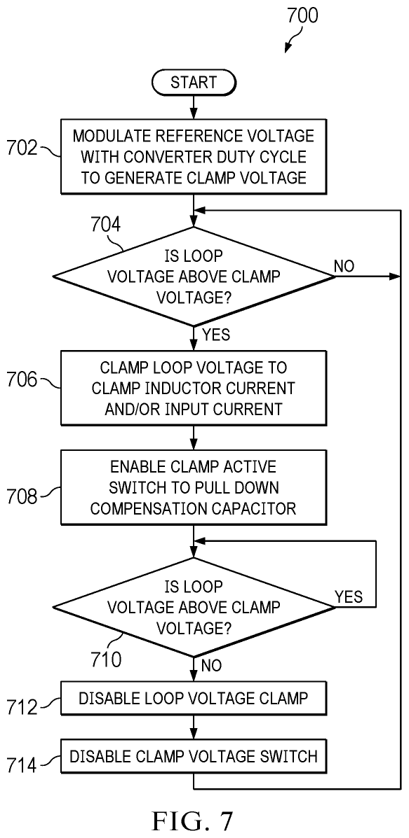

FIG. 7 is a flowchart representative of a method and/or example operations 700 that may be performed by the power converter 100 in conjunction with the clamping circuitry 232 of FIG. 2 to clamp the input current of the power converter 100 in response to a transient event. However, the method and/or operations 700 may be used to clamp and voltage and/or current of the power converter 100. Additionally, although the operations of FIG. 7 are described in conjunction with the clamping circuitry 232 in the power converter 100 of FIGS. 1 and/or 2, the operations may be described in conjunction with any of the clamping circuitry in any power converter. The operations 700 of FIG. 7 begin at block 702, at which the divide-by-duty cycle circuitry 300 modulates a reference voltage (VREF) with the duty cycle over the power converter 100 to generate a clamp voltage (VCLAMP). As described above, the reference voltage is a voltage selected by a user and/or manufacturer to set the maximum input current of the power converter 100.

At block 704, the example gain stage 302 of the clamping circuitry 232 determines if the loop voltage (VLOOP) is above the clamp voltage (VCLAMP). If the example gain stage 302 determines that the loop voltage is not above the clamp voltage (block 704: NO), control returns to block 704. If the example gain stage 302 determines that the loop voltage is above the clamp voltage (block 704: YES), the transistor 304 enables to clamp the loop voltage, which in turn clamps the inductor current and/or the input current (block 706). For example, because the VLOOP circuit controls the operation of the switches Q1, Q2, Q3, Q4 203, 205, 207, 209, clamping the VLOOP voltage can clamp the inductor current which clamps the input current.

At block 708, the example comparator 306 enables the active switch 308 to pull down the compensation capacitor(s) 310, 312 of the outer loop gain circuit 220. The comparator 306 enables the active switch 308 after determining that current clamping is occurring based on a comparison the output of the gain stage 302 to the loop voltage. As described above in conjunction with FIG. 3, pulling down the compensation capacitors 310, 312 increases the speed at which the outer loop gain circuit 220 can regain control of the current and/or voltage regulation after a transient event. At block 710, the, the example gain stage 302 of the clamping circuitry 232 determines if the loop voltage (VLOOP) is above the clamp voltage (VCLAMP). If the example gain stage 302 determines that the loop voltage is above the clamp voltage (block 710: YES), control returns to block 710. If the example gain stage 302 determines that the loop voltage is not above the clamp voltage (block 710: NO), the transistor 304 disables to stop clamping the loop voltage so that the outer loop gain circuit 220 can regain control of the current and/or voltage regulation (block 712). At block 714, the example comparator 306 disables the active switch 308 and control returns to block 704.

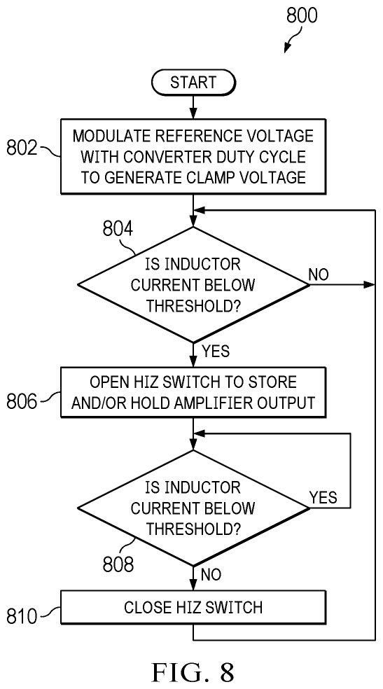

FIG. 8 is a flowchart representative of a method and/or example operations 800 that may be performed by divide-by-duty cycle circuitry 500 of FIG. 5 during discontinuous operation. Although the operations of FIG. 8 are described in conjunction with the divide-by-duty cycle circuitry 500 of FIG. 5 in the power converter 100 of FIGS. 1 and/or 2, the operations may be described in conjunction with any of the modulation circuitry in any power converter. The operations 800 of FIG. 8 begin at block 802, at which the amplifier 402 in conjunction with the feedback circuitry (e.g., the switches 404, 406, the resistor 408, and the capacitor 410) modulates the reference voltage (Vref) with the converter duty cycle to generate the clamp voltage. In some examples, the amplifier 402 generates the clamp voltage by first generating a ground-referenced clamp voltage and the level shifting circuitry 416 level shifts the ground-referenced clamp voltage to a clamp voltage (e.g., referenced to another voltage other than ground using a user and/or manufacturer selected reference loop voltage).

At block 804, the example comparator 501 determines if the inductor current (IL) is below a threshold. For example, the comparator 501 may compare a voltage differential between a first terminal of the inductor 211 and a second terminal of the inductor 211 to determine if the inductor current is positive or negative/zero. As described above in conjunction with FIG. 5, when the inductor current is zero or negative, the power converter 100 may enter into a discontinuous mode to turn off both switches 203, 205 at the same time. Thus, the switches 404, 406 will likewise be turned off at the same time. If the comparator 501 determines that the inductor current is not below the threshold (block 804: NO), control returns to block 804. If the comparator 501 determines that the inductor current is below the threshold (block 804: YES), the example comparator 501 outputs a signal to open the switch 502 to store and/or hold the output of the amplifier 402 in the capacitor 504 (block 806). As described above in conjunction with FIG. 5, opening the switch 502 decouples the output of the amplifier 402 from driving the clamp voltage and the voltage output by the amplifier 402 is stored and held in the capacitor 504 which is used to enable and/or disable the source follower circuitry including the transistor 506 and the current source 508. In this manner, the stored voltage at the capacitor 504 is used to maintain the clamp voltage until discontinuous operation ends.

At block 808, the example comparator 501 determines if the inductor current (IL) is below a threshold. If the comparator 501 determines that the inductor current is below the threshold (block 808: YES), control returns to block 808 to keep the switch 502 open. If the comparator 501 determines that the inductor current is not below the threshold (block 808: NO), the example comparator 501 outputs a signal to close the switch 502 (block 810). In this manner, control of the clamp voltage is returned to operation of the amplifier 402 and/or corresponding feedback circuitry (e.g., the switches 404, 406, the resistor 408, and the capacitor 410). At block 810, control returns to block 804.

In this description, the term “and/or” (when used in a form such as A, B and/or C) refers to any combination or subset of A, B, C, such as: (a) A alone; (b) B alone; (c) C alone; (d) A with B; (e) A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B.

An example manner of implementing one or more portions of the power converter 100 of FIG. 1 is illustrated in FIGS. 2-5. However, one or more of the elements, processes and/or devices illustrated in FIG. 2-5 may be combined, divided, re-arranged, omitted, eliminated and/or implemented in any other way.

Further, the components of FIGS. 2-5 may include one or more elements, processes and/or devices in addition to, or instead of, those illustrated in FIGS. 2-5, and/or may include more than one of any or all of the illustrated elements, processes, and devices. As used herein, the phrase “in communication,” including variations thereof, encompasses direct communication and/or indirect communication through one or more intermediary components, and does not require direct physical (e.g., wired) communication and/or constant communication, but rather also includes selective communication at periodic intervals, scheduled intervals, aperiodic intervals, and/or one-time events.

Further, although the example operations are described with reference to the flowcharts illustrated in FIGS. 7 and/or 8, many other methods of implementing the power converter 100 may alternatively be used. For example, the order of the blocks may be changed, and/or some of the blocks described may be changed, eliminated, or combined.

Descriptors “first,” “second,” “third,” etc. are used herein when identifying multiple elements or components which may be referred to separately. Unless otherwise specified or understood based on their context of use, such descriptors do not impute any meaning of priority, physical order, or arrangement in a list, or ordering in time but are merely used as labels for referring to multiple elements or components separately for ease of understanding the described examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

In the description and in the claims, the terms “including” and “having,” and variants thereof are intended to be inclusive in a manner similar to the term “comprising” unless otherwise noted. Unless otherwise stated, “about,” “approximately,” or “substantially” preceding a value means within +/−10 percent of the stated value. In another example, “about,” “approximately,” or “substantially” preceding a value means within +/−5 percent of the stated value. In another example, “about,” “approximately,” or “substantially” preceding a value means within +/−1 percent of the stated value.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

Although not all separately labeled in the FIG., components or elements of systems and circuits illustrated therein have one or more conductors or terminus that allow signals into and/or out of the components or elements. The conductors or terminus (or parts thereof) may be referred to herein as pins, pads, terminals (including input terminals, output terminals, reference terminals, and ground terminals, for instance), inputs, outputs, nodes, and interconnects.

As used herein, a “terminal” of a component, device, system, circuit, integrated circuit, or other electronic or semiconductor component, generally refers to a conductor such as a wire, trace, pin, pad, or other connector or interconnect that enables the component, device, system, etc., to electrically and/or mechanically connect to another component, device, system, etc. A terminal may be used, for instance, to receive or provide analog or digital electrical signals (or simply signals) or to electrically connect to a common or ground reference. Accordingly, an input terminal or input is used to receive a signal from another component, device, system, etc. An output terminal or output is used to provide a signal to another component, device, system, etc. Other terminals may be used to connect to a common, ground, or voltage reference, e.g., a reference terminal or ground terminal. A terminal of an IC or a PCB may also be referred to as a pin (a longitudinal conductor) or a pad (a planar conductor). A node refers to a point of connection or interconnection of two or more terminals. An example number of terminals and nodes may be shown. However, depending on a particular circuit or system topology, there may be more or fewer terminals and nodes. However, in some instances, “terminal,” “node,” “interconnect,” “pad,” and “pin” may be used interchangeably.

Modifications are possible in the described examples, and other examples are possible, within the scope of the claims.

Example methods, apparatus, systems, and articles of manufacture to dynamically limit current for power converters are disclosed herein. Further examples and combinations thereof include the following: Example 1 includes a circuit comprising an inductor, a plurality of switches coupled to the inductor, switch control circuitry including an input terminal and output terminals, the output terminals of the switch control circuitries coupled to the plurality of switches, a current sensor including an input terminal and an output terminal, the input terminal of the current sensor coupled to the inductor, loop gain circuitry including a first output terminal and a second output terminal, the second output terminal of the loop gain circuitry coupled to the input terminal of the switch control circuitry, and clamping circuitry including modulation circuitry including an input terminal and an output terminal, the input terminal of the modulation circuitry coupled to an input reference voltage terminal, an amplifier including a first input terminal, a second input terminal, and an output terminal, the first input terminal of the amplifier coupled to the first output terminal of the loop gain circuitry of the loop gain circuitry, the second input terminal of the amplifier coupled to the output terminal of the modulation circuitry, and a transistor including a first current terminal, a second current terminal, and a control terminal, the first current terminal of the transistor coupled to the first input terminal of the amplifier and the first output terminal of the loop gain circuitry, the second current terminal of the transistor coupled to a ground terminal, and the control terminal of the transistor coupled to the output terminal of the amplifier.

Example 2 includes the circuit of example 1, wherein the amplifier is a first amplifier, the modulation circuitry including a second amplifier including a first input terminal, a second input terminal, and an output terminal, the first input terminal of the second amplifier coupled to the input reference voltage terminal, a first switch including a first terminal and a second terminal, the first terminal of the first switch coupled to the output terminal of the second amplifier, a second switch including a first terminal and a second terminal, the first terminal of the second switch coupled to the second terminal of the first switch, the second terminal of the second switch coupled to ground, and a resistor including a first terminal and a second terminal, the first terminal of the resistor coupled to the second terminal of the first switch and the first terminal of the second switch, the second terminal of the resistor coupled to the second input terminal of the second amplifier.

Example 3 includes the circuit of example 2, wherein the transistor is a first transistor, the modulation circuitry further including a third switch including a first terminal and a second terminal, the first terminal of the third switch coupled to the output terminal of the second amplifier, a capacitor including a first terminal and a second terminal, the first terminal of the capacitor coupled to the second terminal of the third switch, the second terminal of the capacitor coupled to ground, and a second transistor including a control terminal, a first current terminal, and a second current terminal, the control terminal of the second transistor coupled to the second terminal of the third switch and the first terminal of the capacitor, the first current terminal of the second transistor coupled to a supply voltage, and the second current terminal of the second transistor coupled to the first terminal of the first switch.

Example 4 includes the circuit of example 3, further including a comparator including a first input terminal, a second input terminal, and an output terminal, the first input terminal of the comparator coupled to a first terminal of the inductor via a third amplifier, the second input terminal of the comparator coupled to a second terminal of the inductor via the third amplifier, and the output terminal of the comparator coupled to a third terminal of the third switch.

Example 5 includes the circuit of example 1, wherein the clamping circuitry further includes level shifting circuitry, wherein the second input terminal of the amplifier is coupled to the output terminal of the modulation circuitry via the level shifting circuitry.

Example 6 includes the circuitry of example 5, wherein the plurality of switches is a first plurality of switches, the level shifting circuitry including a second plurality of switches including a first terminal, a second terminal, and a third terminal, the first terminal of the second plurality of switches coupled to the output terminal of the modulation circuitry, the third terminal of the second plurality of switches coupled to the second input terminal of the amplifier, a capacitor including a first terminal and a second terminal, the first terminal of the capacitor coupled to the second terminal of the second plurality of switches, a third plurality of switches including a first terminal, a second terminal, and a third terminal, the second terminal of the third plurality of switches coupled to the second terminal of the capacitor, the third terminal of the third plurality of switches coupled to ground, and a buffer including a first input terminal, a second input terminal, and an output terminal, the first input terminal of the buffer coupled to a reference loop voltage terminal, the second input terminal of the buffer coupled to the output terminal of the buffer and the first terminal of the third plurality of switches, and the output terminal of the buffer coupled to the second input terminal of the buffer 418 and the first terminal of the third plurality of switches.

Example 7 includes the circuit of example 6, wherein the amplifier is a first amplifier, the buffer being implemented by a second amplifier.

Example 8 includes the circuit of example 1, wherein the clamping circuitry further includes a comparator including a first input terminal, a second input terminal, and an output terminal, the first input terminal of the comparator coupled to the first output terminal of the loop gain circuitry, the first input terminal of the amplifier, and the first current terminal of the transistor, the second input terminal coupled to the output terminal of the amplifier and the control terminal of the transistor, and a switch including a control terminal and a first current terminal, the control terminal of the switch coupled to the output terminal of the comparator, and the first current terminal of the switch coupled to ground.

Example 9 includes the circuit of example 8, wherein the first current terminal of the switch is coupled to ground via a current source.

Example 10 includes the circuit of example 8, wherein the switch includes a second current terminal and the transistor is a first transistor, the loop gain circuitry further including a gain stage including a first input terminal, a second input terminal, and an output terminal, the first input terminal of the gain stage coupled to an input voltage terminal of a voltage source, the second input terminal of the gain stage coupled to the input reference voltage terminal, the output terminal of the gain stage coupled to the second current terminal of the switch, a second transistor including a control terminal, a first current terminal, and a second current terminal, the control terminal of the second transistor coupled to the output terminal of the gain stage, the first current terminal coupled to the first output terminal of the loop gain circuitry, the second current terminal coupled to ground, and a capacitor including a first terminal and a second terminal, the first terminal of the capacitor coupled to the output terminal of the gain stage and the control terminal of the second transistor, the second terminal of the capacitor coupled to the second current terminal of the second transistor and ground.

Example 11 includes the circuit of example 1, wherein the amplifier is a first amplifier, the loop gain circuitry including an second amplifier including a first input terminal, a second input terminal, and an output terminal, the first input terminal of the second amplifier coupled to the first output terminal of the loop gain circuitry, the second input terminal of the second amplifier coupled to loop voltage reference terminal, the output terminal of the second amplifier coupled to the input terminal of the switch control circuitry.

Example 12 includes a circuit comprising an inductor, a plurality of switches coupled to the inductor, switch control circuitry configured to control the plurality of switches based on a loop voltage to control the inductor current through the inductor, loop gain circuitry configured to generate the loop voltage based on an input voltage and a reference voltage, and clamping circuitry configured to clamp the loop voltage after the loop voltage exceeds a threshold, the switch control circuitry configured to clamp the inductor current based on the clamping of the loop voltage, wherein the clamping of the inductor current clamps an input current.

Example 13 includes the circuit of example 12, wherein the clamping circuitry includes modulation circuitry to generate a clamp voltage by modulating the reference voltage based on a duty cycle corresponding to the control of the plurality of switches.

Example 14 includes the circuit of example 13, further including a switch to decouple an amplifier of the modulation circuitry when enabled, a capacitor to store an output of the amplifier, a comparator to enable the switch when a discontinuous mode occurs, and a source follower circuit to hold the stored output of the comparator, the clamp voltage based on the held stored output.

Example 15 includes the circuit of example 13, wherein an output of the modulation circuitry is ground referenced, the clamping circuitry further including level shifting circuitry to level shift the output of the modulation circuitry to generate the clamp voltage.

Example 16 includes the circuit of example 15, wherein the clamping circuitry further includes a transistor to clamp the loop voltage when enabled, and an amplifier to enable the transistor based on a comparison of the clamp voltage and the loop voltage.

Example 17 includes the circuit of example 12, wherein the loop gain circuitry controls the inductor current during non-transient events and the clamping circuitry controls the inductor current during transient events.

Example 18 includes the circuit of example 17, wherein the clamping circuitry further includes a switch to pull down a capacitor of the loop gain circuitry when enabled, the pulling down of the capacitor to increase speed of a transition back to loop gain circuitry control of the inductor current based to loop gain circuitry control of the inductor current, and a comparator to enable the switch when the clamping circuitry controls the inductor current.

Example 19 includes a system comprising a battery, and a power converter coupled to the battery to charge the battery, the power converter including an input voltage source to output an input current, loop gain circuitry coupled to the input voltage source, the loop gain circuitry to regulate the input current by generating a loop voltage, and clamping circuitry to clamp the loop voltage based on the input current reaching a threshold.

Example 20 includes the system of example 19, wherein the clamping circuitry is to clamp the loop voltage to clamp the input current.

From the foregoing, it will be appreciated that example systems, apparatus, articles of manufacture, and methods have been described that dynamic limit current in power converters.

Described systems, apparatus, articles of manufacture, and methods improve the efficiency of using a computing device by lower voltage and/or current overshoot in response to a transient condition. Accordingly, examples described herein reduce the potential of damage to one or more circuits caused by undesired overshoot. Described systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been described herein, the scope of coverage of this patent is not limited thereto. On the contrary, this patent covers all systems, apparatus, articles of manufacture, and methods fairly falling within the scope of the claims of this patent.

What is claimed is:

1. A circuit comprising:
switch control circuitry including an input terminal and output terminals, the output terminals of the switch control circuitry coupled to a plurality of switches;
a current sensor including an input terminal and an output terminal, the input terminal of the current sensor structured to be coupled to an inductor;
loop gain circuitry including a first output terminal and a second output terminal, the second output terminal of the loop gain circuitry coupled to the input terminal of the switch control circuitry; and
clamping circuitry including:
modulation circuitry including an input terminal and an output terminal, the input terminal of the modulation circuitry coupled to an input reference voltage terminal;
an amplifier including a first input terminal, a second input terminal, and an output terminal, the first input terminal of the amplifier coupled to the first output terminal of the loop gain circuitry of the loop gain circuitry, the second input terminal of the amplifier coupled to the output terminal of the modulation circuitry; and
a transistor including a first current terminal, a second current terminal, and a control terminal, the first current terminal of the transistor coupled to the first input terminal of the amplifier and the first output terminal of the loop gain circuitry, the second current terminal of the transistor coupled to a ground terminal, and the control terminal of the transistor coupled to the output terminal of the amplifier.

2. The circuit of claim 1, wherein the amplifier is a first amplifier, the modulation circuitry including:
a second amplifier including a first input terminal, a second input terminal, and an output terminal, the first input terminal of the second amplifier coupled to the input reference voltage terminal;
a first switch including a first terminal and a second terminal, the first terminal of the first switch coupled to the output terminal of the second amplifier;
a second switch including a first terminal and a second terminal, the first terminal of the second switch coupled to the second terminal of the first switch, the second terminal of the second switch coupled to ground; and
a resistor including a first terminal and a second terminal, the first terminal of the resistor coupled to the second terminal of the first switch and the first terminal of the second switch, the second terminal of the resistor coupled to the second input terminal of the second amplifier.

3. The circuit of claim 2, wherein the transistor is a first transistor, the modulation circuitry further including:
a third switch including a first terminal and a second terminal, the first terminal of the third switch coupled to the output terminal of the second amplifier;
a capacitor including a first terminal and a second terminal, the first terminal of the capacitor coupled to the second terminal of the third switch, the second terminal of the capacitor coupled to ground; and
a second transistor including a control terminal, a first current terminal, and a second current terminal, the control terminal of the second transistor coupled to the second terminal of the third switch and the first terminal of the capacitor, the first current terminal of the second transistor coupled to a supply voltage, and the second current terminal of the second transistor coupled to the first terminal of the first switch.

4. The circuit of claim 3, further including a comparator including a first input terminal, a second input terminal, and an output terminal, the first input terminal of the comparator structured to be coupled to a first terminal of the inductor via a third amplifier, the second input terminal of the comparator structured to be coupled to a second terminal of the inductor via the third amplifier, and the output terminal of the comparator coupled to a third terminal of the third switch.

5. The circuit of claim 1, wherein the clamping circuitry further includes level shifting circuitry, wherein the second input terminal of the amplifier is coupled to the output terminal of the modulation circuitry via the level shifting circuitry.

6. The circuit of claim 5, wherein the plurality of switches is a first plurality of switches, the level shifting circuitry including:
a second plurality of switches including a first terminal, a second terminal, and a third terminal, the first terminal of the second plurality of switches coupled to the output terminal of the modulation circuitry, the third terminal of the second plurality of switches coupled to the second input terminal of the amplifier;
a capacitor including a first terminal and a second terminal, the first terminal of the capacitor coupled to the second terminal of the second plurality of switches;
a third plurality of switches including a first terminal, a second terminal, and a third terminal, the second terminal of the third plurality of switches coupled to the second terminal of the capacitor, the third terminal of the third plurality of switches coupled to ground; and
a buffer including a first input terminal, a second input terminal, and an output terminal, the first input terminal of the buffer coupled to a reference loop voltage terminal, the second input terminal of the buffer coupled to the output terminal of the buffer and the first terminal of the third plurality of switches, and the output terminal of the buffer coupled to the second input terminal of the buffer and the first terminal of the third plurality of switches.

7. The circuit of claim 6, wherein the amplifier is a first amplifier, the buffer being implemented by a second amplifier.

8. The circuit of claim 1, wherein the clamping circuitry further includes:
a comparator including a first input terminal, a second input terminal, and an output terminal, the first input terminal of the comparator coupled to the first output terminal of the loop gain circuitry, the first input terminal of the amplifier, and the first current terminal of the transistor, the second input terminal coupled to the output terminal of the amplifier and the control terminal of the transistor; and
a switch including a control terminal and a first current terminal, the control terminal of the switch coupled to the output terminal of the comparator, and the first current terminal of the switch coupled to ground.

9. The circuit of claim 8, wherein the first current terminal of the switch is coupled to ground via a current source.

10. The circuit of claim 8, wherein the switch includes a second current terminal and the transistor is a first transistor, the loop gain circuitry further including:
a gain stage including a first input terminal, a second input terminal, and an output terminal, the first input terminal of the gain stage coupled to an input voltage terminal of a voltage source, the second input terminal of the gain stage coupled to the input reference voltage terminal, the output terminal of the gain stage coupled to the second current terminal of the switch;
a second transistor including a control terminal, a first current terminal, and a second current terminal, the control terminal of the second transistor coupled to the output terminal of the gain stage, the first current terminal coupled to the first output terminal of the loop gain circuitry, the second current terminal coupled to ground; and
a capacitor including a first terminal and a second terminal, the first terminal of the capacitor coupled to the output terminal of the gain stage and the control terminal of the second transistor, the second terminal of the capacitor coupled to the second current terminal of the second transistor and ground.

11. The circuit of claim 1, wherein the amplifier is a first amplifier, the loop gain circuitry including an second amplifier including a first input terminal, a second input terminal, and an output terminal, the first input terminal of the second amplifier coupled to the first output terminal of the loop gain circuitry, the second input terminal of the second amplifier coupled to loop voltage reference terminal, the output terminal of the second amplifier coupled to the input terminal of the switch control circuitry.

12. A circuit comprising:
switch control circuitry configured to control a plurality of switches based on a loop voltage to control inductor current through an inductor;
loop gain circuitry configured to generate the loop voltage based on an input voltage and a reference voltage; and
clamping circuitry configured to clamp the loop voltage after the loop voltage exceeds a threshold, the switch control circuitry configured to clamp the inductor current based on the clamping of the loop voltage, wherein the clamping of the inductor current clamps an input current.

13. The circuit of claim 12, wherein the clamping circuitry includes modulation circuitry to generate a clamp voltage by modulating the reference voltage based on a duty cycle corresponding to the control of the plurality of switches.

14. The circuit of claim 13, further including:
a switch to decouple an amplifier of the modulation circuitry when enabled;
a capacitor to store an output of the amplifier;
a comparator to enable the switch when a discontinuous mode occurs; and
a source follower circuit to hold the stored output of the comparator, the clamp voltage based on the held stored output.

15. The circuit of claim 13, wherein an output of the modulation circuitry is ground referenced, the clamping circuitry further including level shifting circuitry to level shift the output of the modulation circuitry to generate the clamp voltage.

16. The circuit of claim 15, wherein the clamping circuitry further includes:
a transistor to clamp the loop voltage when enabled; and
an amplifier to enable the transistor based on a comparison of the clamp voltage and the loop voltage.

17. The circuit of claim 12, wherein the loop gain circuitry controls the inductor current during non-transient events and the clamping circuitry controls the inductor current during transient events.

18. The circuit of claim 17, wherein the clamping circuitry further includes:
a switch to pull down a capacitor of the loop gain circuitry when enabled, the pulling down of the capacitor to increase speed of a transition back to loop gain circuitry control of the inductor current based to loop gain circuitry control of the inductor current; and
a comparator to enable the switch when the clamping circuitry controls the inductor current.

19. A system comprising:
a battery; and
a power converter coupled to the battery to charge the battery, the power converter including:
an input voltage source to output an input current;
loop gain circuitry coupled to the input voltage source, the loop gain circuitry to regulate the input current by generating a loop voltage; and
clamping circuitry to clamp the loop voltage based on the input current reaching a threshold.

20. The system of claim 19, wherein the clamping circuitry is to clamp the loop voltage to clamp the input current.
